(19) United States
(12) Patent Application Publication
(10) Pub. No.: US 2014/0327746 A1
(43) Pub. Date: Nov. 6, 2014

(54) VOLUME RECONSTRUCTION OF AN OBJECT USING A 3D SENSOR AND ROBOTIC COORDINATES

(71) Applicant: iPhoton Solutions, LLC, Fort Worth, TX (US)

(72) Inventors: Marc Dubois, Keller, TX (US); Thomas E. Drake, JR., Fort Worth, TX (US)

(73) Assignee: iPhoton Solutions, LLC, Fort Worth, TX (US)

(21) Appl. No.: 14/270,831

(22) Filed: May 6, 2014

Related U.S. Application Data
(60) Provisional application No. 61/819,972, filed on May 6, 2013.

(51) Int. Cl. H04N 13/02; G06T 15/08; G06T 7/00

(52) U.S. Cl. CPC H04N 13/0282; G06T 7/002; G06T 15/08
USPC 348/50

(57) ABSTRACT

Real-time 3D information may be collected about the shape of an object on which an industrial process is applied. By using the position and orientation information provided by the robot controller to integrate the 3D information provided by the sensor, improved volume information for shapes presenting few features, for example, a slowly varying wall, may be provided. In addition, the total error in the reconstructed volume may be independent from the number of views because the position and orientation information for any view need not rely on the position and orientation information of the previous views.

### CROSS REFERENCE TO RELATED APPLICATION

This application claims the benefit under 35 U.S.C. §119(e) of U.S. Provisional Patent Application Ser. No. 61/819,972 filed on May 6, 2013, entitled “Volume Reconstruction of an Object Using a 3D Sensor and Robotic Coordinates,” which is incorporated by reference in its entirety.

### FIELD OF THE DISCLOSURE

The present disclosure generally relates to volume reconstruction of an object, and more particularly to volume reconstruction of an object using a 3D sensor and robotic coordinates.

### BACKGROUND

Volume reconstruction is a technique to create a virtual volume of an object or complex scene using 3D information from several views. For the volume to be reconstructed, 3D data from each view must be added to the volume using a common coordinate system. A common coordinate system can be created if the position and orientation of each 3D data set is known. When using a single 3D sensor, and when the 3D sensor is moved around an object, the position and orientation of the 3D sensor must therefore be known for each data set. The knowledge of the position and orientation of the 3D sensor has been obtained in the past by using a reference position for the first 3D data set obtained and by calculating the relative change of position and orientation between each subsequent data set. The relative changes of position and orientation between two views is calculated by identifying features in the 3D data common to both views and by calculating what changes in the position and orientation would correspond in the observed change of position of the identified features in the 3D data. This technique is called depth tracking or 3D data tracking. As the number of views increases, the errors in the position and orientation accumulate and the total error may increase. The total error can be kept relatively low using 3D data tracking in the case of irregular shapes found in nature for which several 3D data features can typically be found. However, for industrial applications, objects to be reconstructed in 3D tend to be of smooth and regular shapes with few significant features in the 3D data. Those shapes are not easily tracked by 3D-feature tracking algorithms and those algorithms can lead to major errors in the reconstructed volume.

### SUMMARY

Embodiments of the present disclosure may provide a method for volume reconstruction of an object comprising: using a robot, positioning a three-dimensional sensor around the object; obtaining three-dimensional data from the object; and generating a three-dimensional representation of the object using the three-dimensional data, and position and orientation information provided by the robot. The three-dimensional data may determine the exact position where an industrial process is performed on the object. Different three-dimensional data of the object obtained from several orientations and positions of the robot may be integrated into a common coordinate system to generate the three-dimensional representation of the object. The integrating step may further comprise using the position and orientation information provided by the robot to calculate the change in position and orientation relative to a position and orientation reference; and using the calculated change in position and orientation to integrate the three-dimensional data into a common coordinate system.

Embodiments of the present disclosure also may comprise a system for volume reconstruction of an object comprising: a three-dimensional sensor mounted on a robot; and a processing unit to acquire and process depth information to integrate three-dimensional information of the object into a virtual volume. The processing unit may integrate the three-dimensional information of the object into the virtual volume by using position and orientation information provided by the robot. The three-dimensional sensor, the robot and the processing unit may be connected through communication links. The processing unit may be located on the robot. The processing unit may comprise a three-dimensional sensor processing unit; and an industrial process processing unit, wherein the three-dimensional sensor processing unit provides three-dimensional data from the three-dimensional sensor to the industrial process processing unit through a communication link. The three-dimensional sensor may use one or more spatial and temporal techniques selected from the group comprising: single point illumination, line illumination, multiple line illumination, 2D pattern illumination, and wide-area illumination. The three-dimensional sensor may be a camera combined with an illuminator. The three-dimensional sensor may comprise a camera combined with an illuminator and using a time-of-flight technique.

Other embodiments of the present disclosure may comprise a method for volume reconstruction of an object comprising: defining a position and orientation reference provided by a robot controller for a tool; converting the position and orientation reference into a rotation-translation matrix; inverting the rotation-translation matrix to create a reference matrix; converting the current position and orientation reference into a current rotation-translation matrix; calculating a difference matrix representative of the change in position and orientation between the position and orientation reference and the current position and orientation by multiplying the reference matrix by the current rotation-translation matrix; and using the difference matrix to integrate three-dimensional information into a single virtual volume. The calculating step may integrate information acquired by a three-dimensional sensor at a current position with information already accumulated in the virtual volume.

Further embodiments of the present disclosure may provide a method to calibrate the position and orientation of a three-dimensional sensor relative to a tool on which it is mounted, the tool being mounted on a robotic system, the method comprising: translating the tool near a first object and acquiring three-dimensional data from the first object; and rotating the tool near the first object or a second object and acquiring three-dimensional data from the first or second object. The method may further comprise using the three-dimensional data sets to determine the position and orientation of the three-dimensional sensor relative to the tool that minimizes differences between various three-dimensional data representative of common areas of the first object, or of the first and second objects.

### BRIEF DESCRIPTION OF THE DRAWINGS

For a more complete understanding of this disclosure, reference is now made to the following description, taken in conjunction with the accompanying drawings, in which:

FIG. 1 depicts a robotic system on which a 3D sensor may be mounted according to an embodiment of the present disclosure;

FIG. 2 depicts the robotic system 100 as was depicted in FIG. 1 but in a different position and orientation according to an embodiment of the present disclosure;

FIG. 3 depicts a method to calculate a rotation-translation matrix [A] from a given position and orientation provided by the robot controller for the tool according to an embodiment of the present disclosure;

FIG. 4 depicts different coordinate systems of a robotic system according to an embodiment of the present disclosure;

FIG. 5 depicts steps to reconstruct a volume using position and orientation from a robot system according to an embodiment of the present disclosure;

FIG. 6 depicts an assembly that may include a tool mounted on a robotic system according to an embodiment of the present disclosure;

FIG. 7 depicts an assembly comprising a tool equipped with a 3D sensor and performing an industrial process on an object according to an embodiment of the present disclosure; and

FIG. 8 depicts a communication configuration between the various components of a system according to an embodiment of the present disclosure.

### DETAILED DESCRIPTION

Three-dimensional (3D) volume information for industrial processes using robots can be very useful. Industrial processes may be any operation made during the industrial production of an object to characterize, produce, or modify the object. Drilling, material depositing, cutting, welding, and inspecting, to name a few, are examples of industrial processes. 3D information can be used to help the process or to gather data about how and where the process was applied to and on an object. A 3D mapping system can provide an instantaneous 3D representation of an area of an object. However, instead of using the raw 3D information from a single perspective, the accuracy and precision of that information may be improved by acquiring the information from several different points of view and then constructing a single volume. By using position information of points at the surface of an object from several points of view, it is possible to significantly improve the accuracy and precision of the three-dimensional information of an object. This operation may be referred to as volume reconstruction. Volume reconstruction may allow 3D data to be gathered about a volume significantly larger than what may be covered by a single view of the 3D sensor. Volume reconstruction also may improve the poor calibration often found in the 3D sensor at the edges of a single view area. By averaging over several views, any given point at the surface of an object is unlikely to be measured several times from a point near the edges of the 3D sensor acquisition volume because the edges represent only a small fraction of the total view area.

Embodiments of the present disclosure may provide systems and methods to improve volume reconstruction by using a robot to position a 3D sensor around an object and use the position and orientation of the sensor provided by a robot controller to reconstruct the volume. Additionally, embodiments of the present disclosure may provide methods to calibrate the position and orientation of the 3D sensor mounted in a robotic system.

In embodiments of the present disclosure, a 3D sensor may be mounted on a robot to measure 3D data from an object. The data generated by the 3D sensor can be used to generate a 3D model of the object being processed. 3D information may be taken of a point at the surface of the object from several points of view by moving the sensor using a robot. The position information (x, y, z) for each point may be averaged for several points of view. The information about the position of the point at the surface of the object may be calculated using the 3D information from the sensor combined with position and orientation information provided by the robot.

The 3D data provided by the sensor may be converted to the robot coordinate system. Embodiments of the present disclosure also may provide methods to determine the position and orientation of the sensor relative to the mounting position on the robot tool device. These methods may include taking 3D data from several different positions and orientations of one or several objects to extract the values defining the orientation and position of the 3D sensor relative to the tool from the 3D data sets.

Real-time 3D information may be collected about the shape of an object on which an industrial process is applied. By using the position and orientation information provided by the robot controller to integrate the 3D information provided by the sensor, embodiments of the present disclosure may provide improved volume information for shapes presenting few features, for example, a slowly varying wall. In addition, the total error in the reconstructed volume may be independent from the number of views because the position and orientation information for any view need not rely on the position and orientation information of the previous views.

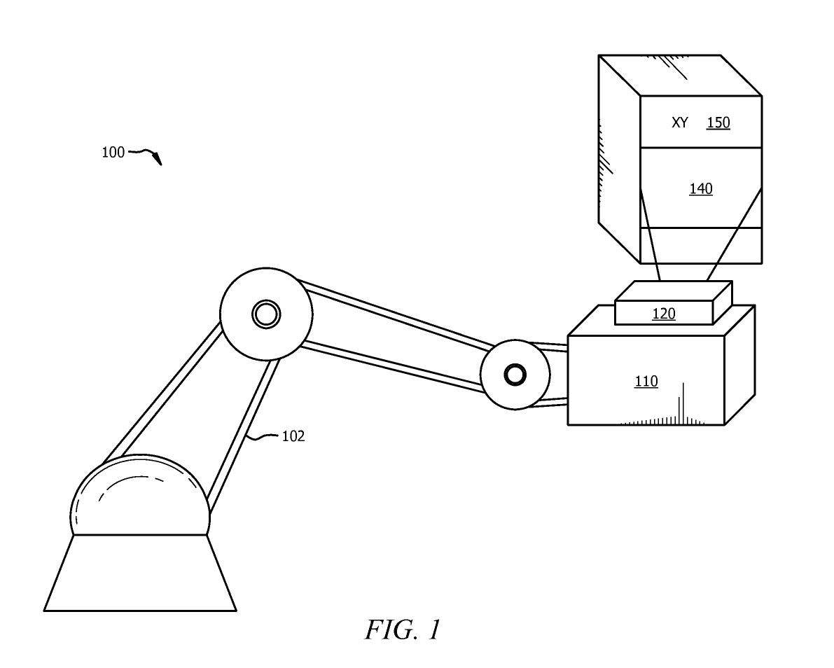

FIG. 1 depicts robotic system 100 on which 3D sensor 120 may be mounted according to an embodiment of the present disclosure. 3D sensor 120 may be mounted on tool 110 that may be mounted on robot 102. 3D sensor 120 may obtain 3D information from area 140 of object 150. The position of 3D sensor 120 may correspond to a given view of area 140 and, in this embodiment, corresponds with the surface denoted as “XY” on object 150. Assuming that the view presented in FIG. 1 is the first view, the 3D information obtained by 3D sensor 120 from area 140 of object 150 may be combined with the position and orientation of tool 110 provided by the controller of robot 102 and added to a virtual volume that may be defined in a given coordinate system. The 3D location of the information provenance may be registered in that coordinate system.

Robotic system 100 can be an articulated robot, as shown in FIG. 1. A robot may be mounted on an additional moving sub-system, such as a linear rail. However, it should be appreciated that other types of robots can also be used, including but not limited to, a gantry robot, without departing from the present disclosure.

3D sensor 120 may use a variety of different spatial, temporal, and coherent illumination technologies, including but not limited to, single point illumination, line illumination, multiple line illumination, 2D pattern illumination, and wide-area illumination. However, it should be appreciated that there may be some embodiments where there may be no illumination. 3D sensor 120 can include a single or multiple detectors. The single or multiple detectors may include single detection elements, linear arrays of detection elements, or two-dimensional arrays of detection elements, such as a camera.

In an embodiment of the present disclosure, 3D sensor 120 may be a camera combined with a 2D pattern illuminator. In another embodiment of the present disclosure, 3D sensor 120 may be a camera combined with a line illuminator. In yet another embodiment of the present disclosure, 3D sensor 120 may be a camera combined with a wide-area illuminator that illuminates an area of the object with a light beam without any particular pattern. It should be appreciated that the 3D sensor may be mounted on a motorized unit independent from the robot so that the line can be moved at the surface of the object to be able to cover an area. The position and orientation of the motorized unit independent from the robot may be taken into account when calculating the position and orientation of the sensor using the position and orientation information provided by the robot controller. In yet another embodiment, 3D sensor 120 may be a camera with an illuminator using a time-of-flight technique to measure 3D shapes. The time-of-flight technique works by measuring the time light takes to travel from the illuminator to each of the elements of the 3D sensor. Time-of-flight techniques can be based on several techniques including short optical pulses, incoherent modulation, and coherent modulation.

In another embodiment of the present disclosure, it should be appreciated that 3D sensor 120 may be a stereo camera. The stereo camera may include two or more cameras without departing from the present disclosure. A stereo camera works by having two or more cameras looking at the same area of an object. The difference in position of the same object features in the image of each camera, along with the known position of each camera relative to each other, may be used to calculate the 3D information of the object. In such an embodiment, it should be appreciated that 3D sensor 120 may be equipped with a 2D pattern illuminator. Such illuminator can provide features recognizable by the cameras for objects that would be otherwise featureless.

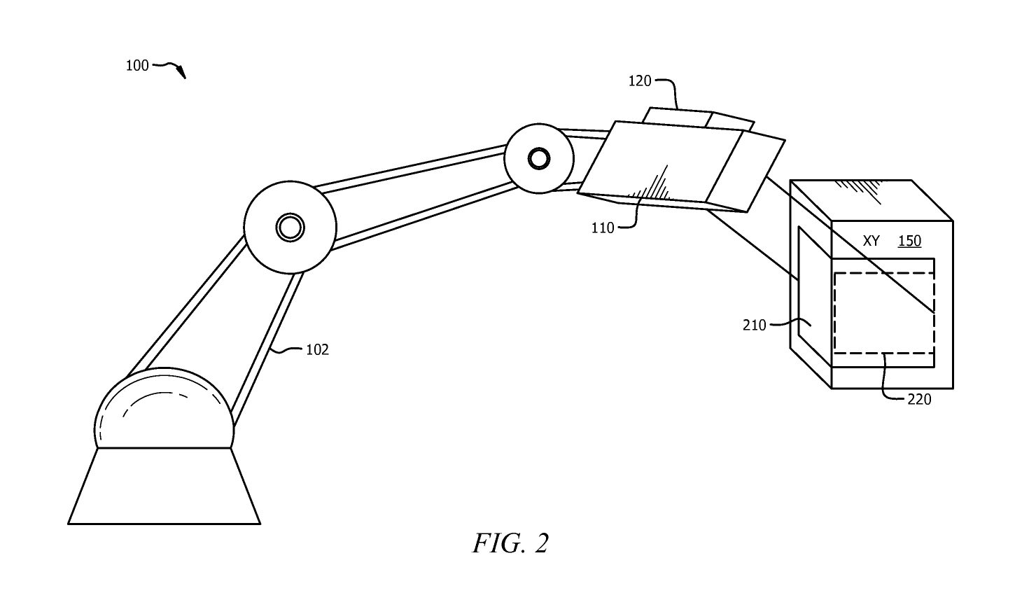

FIG. 2 depicts robotic system 100 as was depicted in FIG. 1 but in a different position and orientation according to an embodiment of the present disclosure. 3D sensor 120 is now in a different position and orientation relative to object 150. In this new position, 3D sensor 120 can now measure 3D information from area 210 of object 150. In this embodiment of the present disclosure, area 210 covers part of two faces of object 150. Section 220 of area 210 is common with area 140 from which 3D information was obtained by 3D sensor 120 in FIG. 1 denoted as surface “XY.” The 3D information obtained by 3D sensor 120 may be combined with the new position and orientation of tool 110 from controller of robot 102. The 3D information outside common area 220 is new and is simply added to the virtual volume.

A virtual volume may be defined by its position, orientation, and dimensions. The position and orientation of the volume may be defined relative to a position and orientation reference. This reference can be any position and orientation in the robot coordinate space. One example of reference is the position and orientation of the 3D sensor at the first data acquisition of a given volume, but it should be appreciated that any position and orientation in the robot coordinate space can be used as a reference without departing from the present disclosure. This position and orientation reference may be defined by a 4×4 matrix, where the first 3 rows and columns may correspond to the orientation and the first 3 rows of the 4th column may correspond to the position. The first three values of the fourth row may always be 0's, and the fourth value may always be 1. This type of matrix may be referred to as a rotation-translation matrix. The position and orientation reference matrix corresponds to a mathematical rotation and translation operation where an object is rotated and translated from the 0,0,0 orientation and from the origin of the coordinate system into the position and orientation reference. After each 3D data acquisition, the matrix [N] corresponding to the rotation-translation operation from the position and orientation reference to the current position and orientation of the 3D sensor may be used to integrate the 3D data into a single common volume. This matrix may be calculated by multiplying the current position and orientation of the depth camera in the robot coordinate system by the inverse of the reference matrix. In the past, the matrix [N] would be calculated using the differences between 3D points acquired from at least two different robot positions.

In an embodiment of the present disclosure, the virtual volume can be defined in smaller volumes, called voxels. Each voxel may correspond to a position inside the virtual volume and may have predefined dimensions. Typically, all voxels defining the virtual volume will have the same dimensions. Each 3D point in the virtual volume belongs to a single voxel. When 3D information is added to the volume, each element of information corresponds to a single 3D point of the virtual volume and therefore belongs to a single voxel. When information is added to a voxel where information is already present, the new information is averaged with the information already present. If more than one element of new information belongs to the same voxel, those elements are combined together. Several algorithms exist to add and combine 3D data to voxels and to virtual volumes.

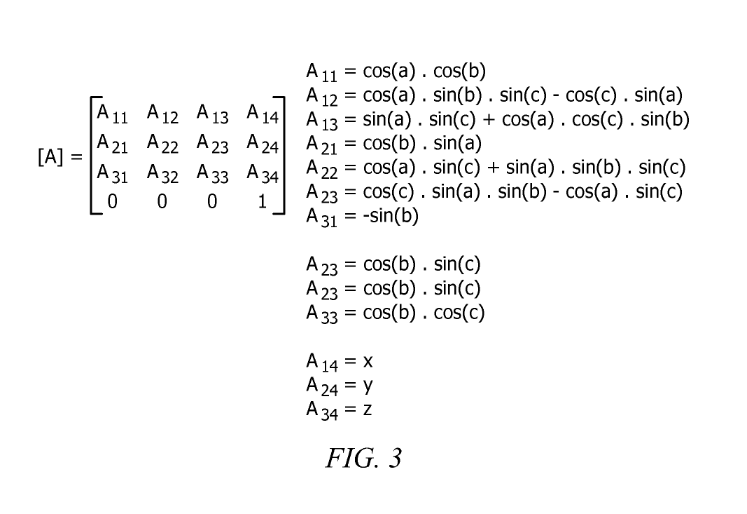

FIG. 3 depicts a method to calculate a rotation-translation matrix [A] from a given position and orientation provided by a robot controller for a tool according to an embodiment of the present disclosure. In one convention, robot positions and orientations may be provided by the robot controller as a set of 6 numbers: x, y, z, a, b, c. The position may be defined by numbers x, y, z which may correspond to the 3D position of the tool in a robot coordinate system. The orientation may be given by numbers a, b, c that correspond to the rotation of the robot tool relative to the reference coordinate system. The three numbers (a, b, c) are the Euler angles, where a is the angle of rotation around axis z, b is the angle of rotation around the new axis y, and c is the angle of rotation around the new x axis. Notice that the convention used in the present disclosure for the position and orientation (x, y, z, a, b, c.) of the robot tool is only one of several other possible conventions. Any other convention where the equations of FIG. 3 would be different could alternatively be used without departing from the present disclosure.

In a method for volume reconstruction according to an embodiment of the present disclosure, at the beginning of the volume reconstruction, a position and orientation reference may be defined. The reference can be the position and orientation of the robot tool where the 3D sensor first acquired a set of 3D data, but other positions and rotations can be used without departing from the present disclosure. After obtaining the reference position and orientation, the reference position and orientation may be converted into a rotation-translation matrix, using equations shown in FIG. 3 to create a matrix [A]. This matrix [A] may be inverted to create a reference matrix [B] ([B]=[A₀]⁻¹). For each 3D data acquisition by the 3D sensor, the position and orientation of the tool on which the 3D sensor is mounted may be obtained from the robot controller as xᵢ, yᵢ, zᵢ, aᵢ, bᵢ, cᵢ. The position and orientation of the tool may be converted into a rotation-translation matrix [Aᵢ] using equations depicted in FIG. 3. The change of position and orientation between the position and orientation reference and the current position and orientation may be defined by the matrix [Nᵢ] equal to the multiplication of matrices [Aᵢ] and [B]

[Nᵢ]=[Aᵢ][B] Equation (1)

Matrix [Nᵢ] therefore may be the rotation-translation matrix giving the rotation and translation of the 3D sensor from the position and orientation reference to the current position and orientation. Matrix [Nᵢ] may be used to integrate the information acquired by the 3D sensor at the current position with the information already accumulated in the virtual volume.

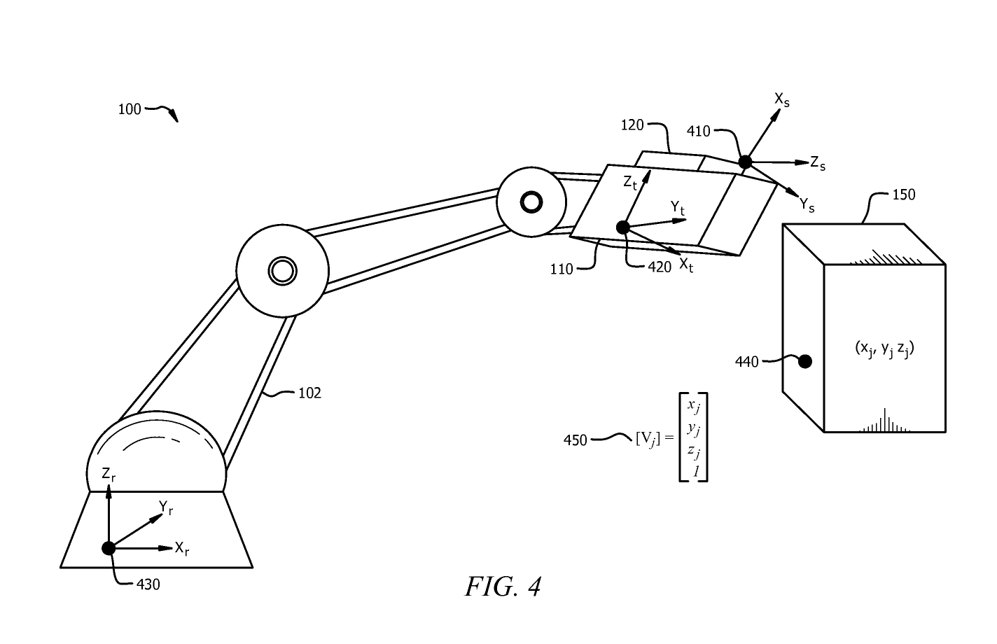

FIG. 4 depicts different coordinate systems of robotic system 100 according to an embodiment of the present disclosure. Data from 3D sensor 110 from any point 440 may be provided as sets of (xⱼ, yⱼ, zⱼ) values, where each set represents a point in space in the coordinate system of the 3D sensor (Xₛ, Yₛ, Zₛ) 410. Data from sensor 110 may be converted from sensor coordinate system 410 to robot tool coordinate system (Xₜ, Yₜ, Zₜ) 420. To convert data of point 440 from the coordinate system of 3D sensor 410 to the coordinate system of tool 420, the 3D sensor (xⱼ, yⱼ, zⱼ) values may be set as a position vector [Vⱼ] 450 and multiplied by matrix [S] corresponding to the rotation and translation required to make coordinate system of 3D sensor 410 coincident with coordinate system of tool 420. To convert the data into the coordinate system of robot 430, position vector [Vⱼ] must also be multiplied by matrix [T] corresponding to the rotation and translation necessary to make coordinate system of tool 420 coincident with the coordinate system of the robot. The resulting 3D data in the coordinate system of the robot may now be represented by a position vector [Dᵢⱼ] that is defined by

[Dᵢⱼ]=[Tᵢ][S][Vⱼ] Equation (2)

In this equation, i is the index for each view and j is the index for the 3D data points acquired by the 3D sensor in each view. The rotation-translation matrix [Tᵢ] may be calculated using the orientation and translation provided by the robot controller xᵢ, yᵢ, zᵢ, aᵢ, bᵢ, cᵢ and the equation provided in FIG. 3.

The rotation-translation matrix [S] may be calculated by the equations of FIG. 3 using the translations xₛ, yₛ, zₛ along the tool coordinate system (Xₜ, Yₜ, Zₜ) and rotations aₛ, bₛ, cₛ to make sensor coordinate system 410 coincident with tool coordinate system 420. The values xₛ, yₛ, zₛ, aₛ, bₛ, cₛ, may be fixed for a given robotic system 100. Those values can be determined in advance during the design and assembly of tool 120 and sensor 110. However, very often, sensor 110 may be added on existing tool 120 and values xₛ, yₛ, zₛ, aₛ, bₛ, cₛ are not known. Those values can then be measured. The measurement of those values can be difficult because the position of the origin of the coordinate systems of tool 420 and of sensor 410 can be virtual points that do not correspond to well defined mechanical features. Orientation is also intrinsically more difficult to measure directly.

Another approach to evaluate values xₛ, yₛ, zₛ, aₛ, bₛ, cₛ may include using data from 3D sensor 110 after it is mounted on tool 120. The 3D data may then be used to calculate the xₛ, yₛ, zₛ, aₛ, bₛ, cₛ. This approach is called calibration. In one calibration technique, an approximation may be used for the xₛ, yₛ, zₛ, aₛ, bₛ, cₛ values based on design, measured values, or common sense for example. The sensor may be oriented by moving the tool such that the sensor coordinate system 410 is as parallel as possible to robot coordinate system 430. Then 3D data may be acquired from an object that has a flat surface parallel to an axis of robot coordinate system 430, xₛ for example, while moving the tool along the parallel axis of robot coordinate system 430. While looking at the 3D data acquired from two different tool positions, the mismatch between the two sets of 3D data of the flat surface and the distance traveled by the tool provides a good estimate of the corresponding rotation value, bₛ for example. The same approach may be used for the two other axes to determine the other angles. Then, the sensor may be positioned again with its coordinate system 410 parallel to the coordinate system of the robot. The tool is then rotated around the main axes and 3D data may be acquired from at least two different rotation angles. The mismatch between the two sets of 3D data relative to an object point or surface and the rotation can be used to evaluate one translation value xₛ, yₛ, zₛ. For example, if the tool is rotated by 180° around axis Yₛ and data from the same point on the object can be obtained from the two positions, the mismatch between the y values of the two data sets will be equal to twice the y, value. More than two sets of 3D data from more than two angles can be necessary. Making those measurements by rotating around the three axes of the robot coordinate system will provide a first approximation for the xₛ, yₛ, zₛ, aₛ, bₛ, cₛ. By repeating the process from the beginning using the new sets of xₛ, yₛ, zₛ, aₛ, bₛ, cₛ values, those values will converge towards the actual values. It is not necessary to acquire the data again if 3D data were saved in sensor coordinate system 410 and the process can be repeated several times using the same data to iteratively calculate xₛ, yₛ, zₛ, aₛ, bₛ, cₛ values with the required accuracy.

If an object that has 3D features that can be identified automatically by a computer algorithm, another calibration technique can be used. In this calibration technique, 3D data sets of the object may be obtained from multiple views corresponding to several orientations and positions of the tool. The xₛ, yₛ, zₛ, aₛ, bₛ, cₛ may then be set as variables in an error minimization algorithm like the Levenberg-Marquardt algorithm. The variations between the 3D data sets of each 3D features of the object are minimized using the chosen algorithm. The xₛ, yₛ, zₛ, aₛ, bₛ, cₛ values corresponding to the smallest variation then correspond to the best estimate for those values.

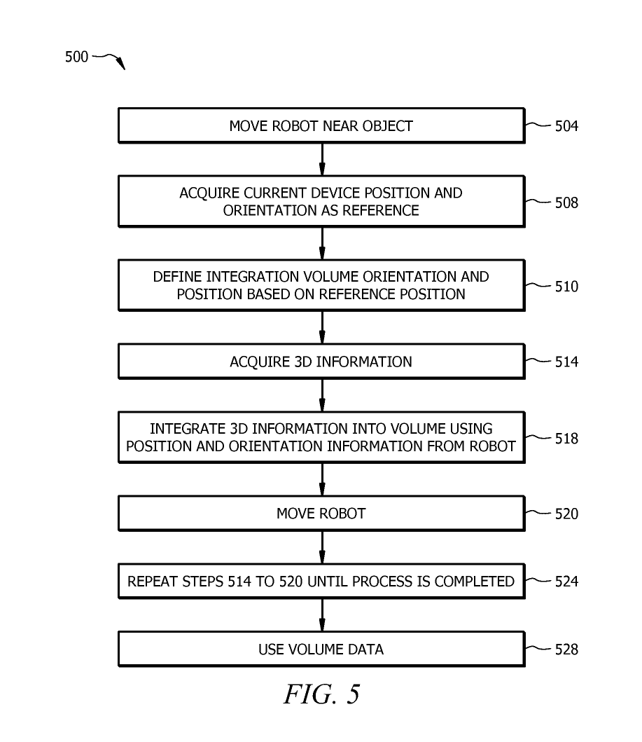

FIG. 5 depicts steps 500 to reconstruct a volume using position and orientation from a robot system according to an embodiment of the present disclosure. In step 504, a robot may be moved near an object. In step 508, current device position and orientation may be acquired as reference. Then the integration volume orientation and position may be defined based on reference position in step 510. 3D information may be acquired in step 514. The 3D information may be integrated into volume using position and orientation information from the robot in step 518. In step 520, the robot may be moved. It should be appreciated that steps 514-520 may be repeated until the processed is completed (step 524). In step 528, the volume data may be used.

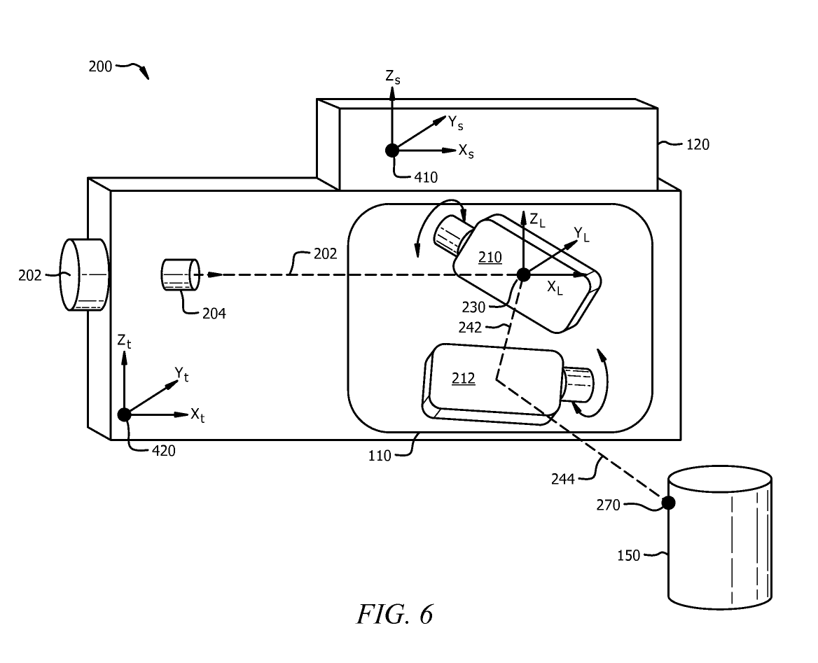

FIG. 6 depicts assembly 200 that may include tool 110 mounted on robotic system 100 as depicted in FIGS. 1 and 2 (wherein robot 102 is not depicted in FIG. 6) according to an embodiment of the present disclosure. Tool 110 would be attached to robot 102 at attachment 202 and equipped with 3D sensor 120 and performing an industrial process on object 150. Tool 110 shown in FIG. 6 contains the delivery optics of an industrial process system. In an embodiment of the present disclosure, tool 110 is shown in FIG. 6 as containing first and second optical elements 210 and 212, and at least one optical beam 202. First and second optical elements 210 and 212 can be mirrors, for example, and optical beam 202 can be a virtual optical beam path or an actual laser beam. However, any other type of industrial tool could be used without departing from the present disclosure. In this embodiment of the present disclosure, optical beam 202 originates from point optical origin point 204 inside tool 110 and hits origin of coordinate system 230, in the present case, the center of optical element 210. Origin point 204 and the orientation of beam 202 remains substantially fixed relatively to origin of coordinate system 230. 3D sensor 120 has pre-determined spatial relationship relative to origin of coordinate system 230. Optical element 210 can rotate and is designed in such a way that when optical element 210 rotates, origin of coordinate system 230 may remain essentially fixed relative to origin point 204. This can be accomplished by making the rotation axis of optical element 210 lie on the surface of optical element 210 and by making origin of coordinate system 230 coincide with both surface and rotation axis of optical element 210. However, it is not essential for origin of coordinate system 230 to coincide with an actual mechanical or optical point. Origin of coordinate system 230 can be virtual and correspond to any fixed point relatively to tool 110 and to 3D sensor 120 without departing from the present disclosure.

After being reflected by optical element 210, optical beam 202 may go to second optical element 212. The orientation of optical beam section 242 is not fixed relative to origin of coordinate system 230 and may depend on orientation of optical element 210. After being reflected by second optical element 212, optical beam section 244 may go to object 150. The orientation of optical beam section 244 may not be pre-determined relative to the origin of coordinate system 230 and may depend on the orientations of both optical elements 210 and 212. Optical beam section 244 may hit the surface of object 150 at point 270. Position of point 270 on object 150 may depend on orientations of both first and second optical elements 210 and 212 and on position of object 150. The position of object 150 may be measured by 3D sensor 120 relative to the origin of coordinate system 230, and the orientations of both first and second optical elements 210 and 212 are known because they are controlled by a remote processing unit. For any given orientations of first and second optical elements 212 and 214, there may be a single point in space corresponding to any specific distance or depth relative to origin of coordinate system 230. Therefore, using the orientations of first and second optical elements 210 and 212, and using the distance information provided by 3D sensor 120, the position of point 270 at surface of object 150 can be calculated. For example, if tool 110 is a head for optical inspection of parts, optical beam 204 could substantially correspond to a laser beam. The laser beam would substantially follow the path shown by optical beam 204, including optical beam section 242 and 244, and hit object 150 at point 270.

System 200 of FIG. 6 may have its own coordinate system. The data from the industrial process may be converted into a coordinate system common to the coordinate system of the 3D sensor. Position data from industrial process might be point 270 where laser beams 244 are on object 150, for example. One approach would be locating both coordinate systems in the robot coordinate system, but other common coordinate systems may be used without departing from the present disclosure. In the case of 3D sensor 120, for which coordinate system 410, is shown in FIG. 6, this operation may be represented by equation (2). [S] would be the rotation-translation matrix representative of the position and orientation of coordinate system 230 relative to the coordinate system of tool 420.

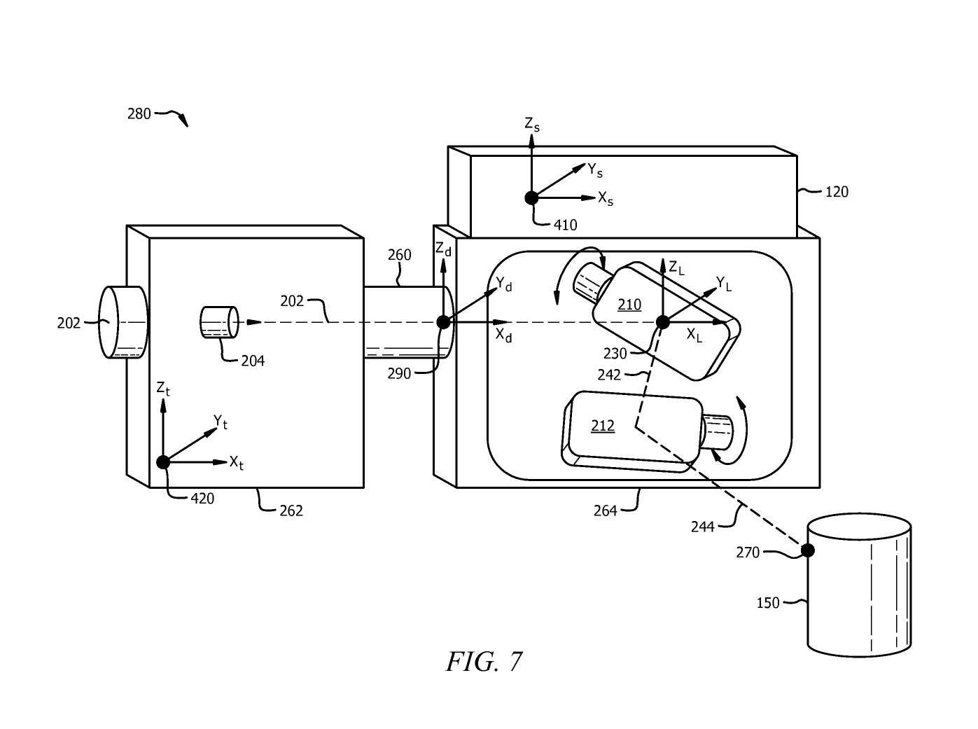

FIG. 7 depicts assembly 280 comprising tool 110 equipped with 3D sensor 120 and performing an industrial process on object 150 according to an embodiment of the present disclosure. Tool 110 may include section 262 that may be attached to a robot at attachment 202 and section 264 that may be attached to section 262 through rotation axis 260. A remote processing unit may control rotation axis 260, and the orientation of section 264 may be known relative to section 262. 3D sensor 120 may be mounted on tool section 264.

FIG. 7 shows the case of an inspection system. The axis of rotation axis 260 may coincide with optical beam 202. In this embodiment of the present disclosure, origin of coordinate system 230 at surface of optical element 210 may coincide with both surface and rotation axis of optical element 210. Therefore, the position of origin of coordinate system 230 may remain the same relative to section 262 for all orientations of rotation axis 260. However, the origin of coordinate system 230 may not coincide with the axis of rotation axis 260 or with any actual mechanical or optical point. Origin of coordinate system 230 can be virtual and correspond to any fixed point relative to section 264 and to 3D sensor 120. The position of origin of coordinate system 230 relative to section 262 can be calculated using the known value of rotation axis 260.

Rotation axis 260 can be independent from the robot controller and the position and orientation information provided by the robot controller might not take into account the position and orientation of rotation axis 260. To convert the position information from 3D sensor 120 and from measurements into the coordinate system of the robot, multiplication by the rotation-translation matrix [Mₖ] representative of the position and orientation of coordinate system 290 of tool section 264 relative to coordinate system 420 of the tool. In the present case, the index k would indicate a specific orientation of tool section 264 relative to tool section 262. For 3D sensor 120:

[Dᵢⱼₖ]=[Tᵢ][Mₖ][S][Vᵢ] Equation (3)

[S] is the rotation-translation matrix representative of the position and orientation of coordinate system 410 of 3D sensor 120 relative to coordinate system 290 of tool sub-section 264.

Notice that some industrial processes do not require several robotic movements. For measurements, the robot may remain immobile while mirrors 210 and 212 move laser beams 244 at surface of object 150. During this process, 3D sensor 120 has the same view and cannot acquire more data to improve accuracy of the reconstructed volume. However, it is possible for 3D sensor 120 to acquire data while tool 110 is moved into position by the robot for the actual industrial process. It is also possible that prior and after the actual industrial process, small robotic movements may be added to provide more views to 3D sensor 120 in order to further improve the accuracy of the reconstructed volume.

The reconstructed volume can be used to position the data from the measurements into 3D space. The system might not know the exact (x,y,z) coordinates of point 270 on object 150 in its own coordinate system 230 because it might lack the distance between point 270 and the system. However, because the angular positions of mirrors 210 and 212 are known, the orientation of laser beams 244 is also known. Therefore, the orientation of laser beams 244 in combination with the 3D data from 3D sensor 120 may provide the full information about the position of point 270 at the surface of object. Once the 3D information for all data points of the system are known, all data can be put in the same coordinate system and be presented in an integrated manner to the operator evaluating the data from the industrial process.

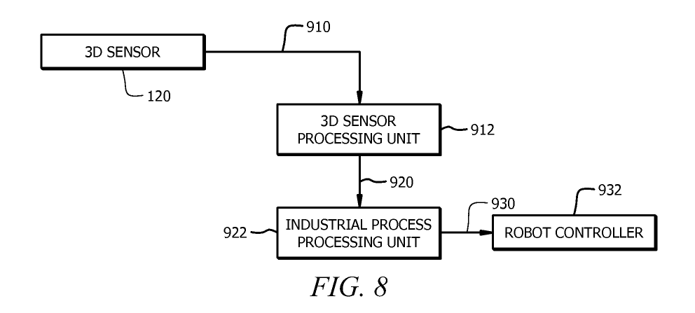

FIG. 8 depicts a communication configuration between the various components according to embodiments of the present disclosure. 3D sensor 120 may be mounted on a robot. 3D sensor 120 may be connected through communication link 910 to 3D sensor processing unit 912. Communication link 912 may include but is not limited to an analog electrical link, an optical fiber link, or a digital electrical link like a USB (Universal Serial Bus) or a network cable or any other digital link. 3D sensor processing unit 912 can be located on the robot. 3D sensor processing unit 912 may provide the 3D data from 3D sensor 912 to the industrial process processing unit 922 through communication link 920. Communication link 920 may include but is not limited to a network communication link. The network communication link can be wired or wireless. The communication protocol between 3D sensor processing unit 912 and industrial process processing unit may include but is not limited to UDP or TCP-IP. The tool position and orientation information may be provided by robot controller 932 to industrial process processing unit 922 through communication link 930. Once again, communication link 930 can be a network communication link. The network communication link can be wired or wireless. The communication protocol between Industrial process processing unit 922 and robot controller may include but is not limited to UDP or TCP-IP. It should be appreciated that the communication configuration shown in FIG. 8 is an example and variations may be provided without departing from the present disclosure. For example, robot controller 932 could be connected directly to 3D sensor processing unit 912. Also, some processing units may perform more than one function.

Additional parameters like angular position of mirrors and angular position of a rotation axis, even though not shown in FIG. 8, would be taken into account in the processing of the data by a processing unit, such as industrial process processing unit 922.

It also should be appreciated that communication between robot controller 932 and industrial process processing unit 922 should be fast enough so that the position and orientation information provided by robot controller 932 may correspond to the actual position and orientation of the tool.

Various benefits may be provided by embodiments of the present disclosure including but not limited to, integrating 3D data from a 3D sensor into a virtual volume using position and orientation information provided by a robotic system, using a position and an orientation in a robotic system coordinate system as the reference position of a virtual volume for surface volume reconstruction of an object, using the multiplication of a rotation-translation matrix of the current position and orientation of a 3D sensor by the inverse of a rotation-translation matrix of a position and orientation reference to calculate the change of orientation and position of a 3D sensor relative to the reference position and orientation, calibrating the position and orientation of a 3D sensor relative to the tool of a robotic system on which the sensor is mounted by moving and rotating the tool using the robotic system along defined axes using defined orientations of the tool, calibrating the position and orientation of a 3D sensor relative to the tool of a robotic system on which the sensor is mounted by acquiring 3D data sets of an object from several views and using the 3D data sets to find the position and orientation of the 3D sensor relative to the tool that minimize the variations in the 3D position, continuous 3D mapping while the robot is in motion for an industrial process (providing improved reconstruction accuracy without adding any delays to the robotic process), adding small robotic movements not necessary to industrial process but that would improve volume reconstruction accuracy without increasing time of the industrial process, using 3D information from 3D sensor to determine the exact position where an industrial process is performed on an object, and using 3D information form 3D sensor to integrate data from an industrial process into a common coordinate system.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for volume reconstruction of an object comprising:
using a robot, positioning a three-dimensional sensor around the object;
obtaining three-dimensional data from the object; and
generating a three-dimensional representation of the object using the three-dimensional data, and position and orientation information provided by the robot.

2. The method of claim 1 wherein the three-dimensional data determines the exact position where an industrial process is performed on the object.

3. The method of claim 1 wherein different three-dimensional data of the object obtained from several orientations and positions of the robot are integrated into a common coordinate system to generate the three-dimensional representation of the object.

4. The method of claim 3, the integration step further comprising:
using the position and orientation information provided by the robot to calculate the change in position and orientation relative to a position and orientation reference; and
using the calculated change in position and orientation to integrate the three-dimensional data into a common coordinate system;

5. A system for volume reconstruction of an object comprising:
a three-dimensional sensor mounted on a robot; and
a processing unit to acquire and process the depth information to integrate three dimensional information of the object into a virtual volume.

6. The system of claim 5 wherein the processing unit integrates the three-dimensional information of the object into a virtual volume by using position and orientation information provided by the robot.

7. The system of claim 5 wherein the three-dimensional sensor, the robot, and the processing unit are connected through communication links.

8. The system of claim 5 wherein the processing unit is located on the robot.

9. The system of claim 5, the processing unit comprising:
a three-dimensional sensor processing unit; and
an industrial process processing unit,
wherein the three-dimensional sensor processing unit provides three-dimensional data from the three-dimensional sensor to the industrial process processing unit through a communication link.

10. The system of claim 5 wherein the three-dimensional sensor uses a technology selected from the group comprising:
single point illumination, line illumination, multiple line illumination, 2D pattern illumination, and wide-area illumination.

11. The system of claim 5 wherein the three-dimensional sensor comprises a camera combined with an illuminator.

12. The system of claim 5 wherein the three-dimensional sensor comprises a camera combined with an illuminator and using a time-of-flight technique.

13. A method for volume reconstruction of an object comprising:
defining a position and orientation reference provided by a robot controller for a tool;
converting the position and orientation reference into a rotation-translation matrix;
inverting the rotation-translation matrix to create a reference matrix;
converting the current position and orientation reference into a current rotation-translation matrix;
calculating a difference matrix representative of the change in position and orientation between the position and orientation reference and the current position and orientation by multiplying the reference matrix with the current rotation-translation matrix; and
using the difference matrix to integrate three-dimensional information into a single virtual volume.

14. The method of claim 13 wherein the calculating step integrates information acquired by a three-dimensional sensor at a current position with information already accumulated in the virtual volume.

15. A method to calibrate the position and orientation of a three dimensional sensor relative to a tool on which it is mounted, the tool being mounted on a robotic system, the method comprising:
translating the tool near a first object and acquiring a first three-dimensional data set from the first object; and
rotating the tool near the first object or a second object and acquiring a second three-dimensional data set from the first or second object.

16. The method of claim 15 further comprising:
using the first and second three-dimensional data sets to determine the position and orientation of the three-dimensional sensor relative to the tool that minimizes differences between the various three-dimensional data representative of common areas of the first object.

17. The method of claim 15 further comprising:
using the first and second three-dimensional data sets to determine the position and orientation of the three-dimensional sensor relative to the tool that minimizes differences between the various three-dimensional data representative of common areas of the first and second objects.
